(19) United States
(12) Patent Application Publication
(10) Pub. No.: US 2025/0234169 A1
(43) Pub. Date: Jul. 17, 2025

(54) TECHNIQUES FOR AN INTELLIGENT MONITORING DEVICE

(71) Applicant: Digi International Inc., Hopkins, MN (US)

(72) Inventors: Gil A. Dror, Newton, MA (US); Sammy Kolt, Johns Creek, GA (US); Guy Yehiav, Wellesley, MA (US); Hanan Hayot, Newton, MA (US); Jason Driscoll, Granger, IN (US)

(73) Assignee: Digi International Inc., Hopkins, MN (US)

(21) Appl. No.: 19/011,221

(22) Filed: Jan. 6, 2025

Related U.S. Application Data
(60) Provisional application No. 63/620,654, filed on Jan. 12, 2024.

(51) Int. Cl. H04W 4/35; G06Q 10/0833; H04W 4/02

(52) U.S. Cl. CPC H04W 4/35; G06Q 10/0833; H04W 4/02

(57) ABSTRACT

Techniques are provided for an intelligent monitoring device (IMD) configured to monitor condition(s) of good(s), for example during deployment or transportation of such good(s). The IMD is capable of transmitting telemetry data directly to a wide area network, whether indoors or outdoors, to be delivered to a central processing system, and/or storing telemetry data. The good(s) may optionally be packaged for transportation with packaging material, e.g., as a pallet, used in transportation of the good(s). The IMD is configured to be mounted on the good(s) to be monitored or the packaging material used in transportation of the good(s). The IMD includes batter(ies) so that it need not be tethered to an external power source. To conserve battery power, the IMD is configured to reduce power consumption of one or more IMD components when part or all of such components are not needed at the time for operation of the IMD.

### CROSS-REFERENCE TO RELATED APPLICATIONS

The present application claims benefit of U.S. Patent Application Ser. No. 63/620,654 filed Jan. 12, 2024; the entire contents of the aforementioned patent application are incorporated herein by reference as if set forth in its entirety.

### BACKGROUND

Monitoring devices are used to determine location and/or a condition of a device. Currently available monitoring devices are generally large, bulky, and require a connection to external power in order to operate. Smaller location and condition monitoring devices are also available, but these devices generally have limited capability and rely on direct communications with personal area networks (PANs) and/or local area networks (LANs) to a gateway device that includes a cellular connection in order to transmit location or condition data. This requires a costly investment in deploying infrastructure such access points for PANs and/or LANs in diverse geographic locations.

### SUMMARY OF THE INVENTION

In some aspects, the techniques described herein relate to a method of monitoring one or more goods, the method including: receiving, directly from a wide area network, configuration data for an intelligent monitoring device (IMD) configured to be mounted on the one or more goods or on packaging used to transport the one or more goods; wherein the configuration data includes one or more measurement parameters, one or more event conditions, and one or more actions; in response to the one or more measurement parameters, receiving data about the IMD including data about a geographic location of the IMD, and a time of day and a date about when the geographic location of the IMD was obtained or an event condition occurred; using at least a portion of the received data, evaluating whether at least one of the one or more event conditions has transpired, wherein each evaluated event conditions is associated with at least one of the one or more measurement parameters; and determining that the at least one of the one or more event conditions has transpired, then performing at least one of the one or more actions, wherein each performed action is associated with one or more transpired event conditions; wherein the transpired actions include at least one of: (a) transmitting, direction over the wide area network, data about the one or more transpired event conditions, (b) reducing power consumption of one or more first components of the IMD, (c) activating one or more second components of the IMD, and (d) receiving data of at least one other data type.

In some aspects, the techniques described herein relate to a non-transitory computer readable medium storing a program causing at least one processor to execute a process to monitor one or more goods, the process including: receiving, directly from a wide area network, configuration data for an intelligent monitoring device (IMD) configured to be mounted on the one or more goods or on packaging used to transport the one or more goods; wherein the configuration data includes one or more measurement parameters, one or more event conditions, and one or more actions; in response to the one or more measurement parameters, receiving data about the IMD including data about a geographic location of the IMD, and a time of day and a date about when the geographic location of the IMD was obtained or an event condition occurred; using at least a portion of the received data, evaluating whether at least one of the one or more event conditions has transpired, wherein each evaluated event conditions is associated with at least one of the one or more measurement parameters; and determining that the at least one of the one or more event conditions has transpired, then performing or causing performance of at least one of the one or more actions, wherein each performed action is associated with one or more transpired event conditions; wherein the transpired actions include at least one of: (a) transmitting, directly over the wide area network, data about the one or more transpired event conditions, (b) reducing power consumption of one or more first components of the IMD, (c) activating one or more second components of the IMD, and (d) receiving data of at least one other data type.

In some aspects, the techniques described herein relate to an intelligent monitoring device (IMD) configured to monitor one or more goods, the IMD including: processing circuitry; one or more sensors communicatively coupled to the processing circuitry; a radio communicatively coupled to the processing circuitry, and configured to be directly communicatively coupled to a wide area network; one or more batteries; power management circuitry electrically coupled to the one or more batteries, the processing circuitry, and the radio; wherein the processing circuitry is configured to: receive, through the radio and from the wide area network, configuration data for IMD, wherein the IMD configured to be mounted on the one or more goods or on packaging used to transport the one or more goods; wherein the configuration data includes one or more measurement parameters, one or more event conditions, and one or more actions; in response to the one or more measurement parameters, receiving data, from the radio and/or the one or more sensors, about the IMD including data about a geographic location of the IMD, and a time of day and a date about when the geographic location of the IMD was obtained or an event condition occurred; using at least a portion of the received data, evaluating whether at least one of the one or more event conditions has transpired, wherein each evaluated event conditions is associated with at least one of the one or more measurement parameters; and determining that the at least one of the one or more event conditions has transpired, then performing or causing performance of at least one of the one or more actions, wherein each performed action is associated with one or more transpired event conditions; wherein the transpired actions include at least one of: (a) transmitting, directly over the wide area network, data about the one or more transpired event conditions, (b) reducing power consumption of one or more first components of the IMD, (c) activating one or more second components of the IMD, and (d) receiving data of at least one other data type.

### BRIEF DESCRIPTION OF THE DRAWINGS

Comprehension of embodiments of the invention is facilitated by reading the following detailed description in conjunction with the annexed drawings, in which:

FIG. 1A illustrates a block diagram of one embodiment of an intelligent measurement device;

FIG. 1B illustrates a diagram of one embodiment of configuration data;

FIG. 2 illustrates a block diagram of one embodiment of a system including intelligent monitoring device(s);

FIG. 3 illustrates a flow diagram of one embodiment of a method of monitoring good(s); and

FIG. 4 illustrates a flow diagram of one embodiment of a method of processing telemetry data.

### DETAILED DESCRIPTION

Embodiments of the invention implement techniques for an intelligent monitoring device (IMD) configured to monitor condition(s) of good(s), for example during deployment or transportation of such good(s). The IMD is capable of transmitting telemetry data directly to a wide area network (WAN), whether indoors or outdoors, to be delivered to a central processing system, and/or storing telemetry data. The good(s) may optionally be packaged for transportation with packaging material, e.g., as a pallet, used in transportation of the good(s). The IMD is configured to be mounted on the good(s) to be monitored or the packaging material used in transportation of the good(s). The IMD includes batter(ies) so that it need not be tethered to an external power source.

Operation of the IMD may change based on a remotely provided command received from the WAN, e.g., from a remote, or central, processing system, or by the IMD as a result of data derived by the IMD, e.g., based on data from sensor(s) of the IMD. For example, the IMD may be configured to activate and/or deactivate certain component(s), e.g., sensor(s), input/output circuitry, and/or a radio, of the IMD, based a change of condition(s) detected by the IMD. Such condition parameter(s) include state variable(s) and/or environmental parameter(s) of the IMD. State variables include without limitation orientation of the IMD, velocity of the IMD, movement of the IMD, vibration of the IMD, acceleration of the IMD, or deceleration of the IMD. Environmental parameters of the IMD include without limitation temperature, humidity, and pressure. Further examples are provided below.

To conserve electrical power stored in batter(ies) of the IMD, the IMD is configured to reduce power consumption of one or more components of the IMD when part or all of such components are not needed at the time for operation of the IMD. For example, as further illustrated elsewhere herein, a radio of the IMD may not be powered until data, e.g., an alert and/or an event, needs to be transmitted from or received by the IMD. Optionally, the IMD may periodically power up and down certain components, for example, the radio and/or one or more sensors to obtain data. The radio may be periodically powered up and down to permit reception of new configuration data and/or an update of a work flow, and/or to determine geographic location of the IMD.

A non-exclusive list of examples of uses of the IMD follows. Optionally, the IMD can monitor a path of travel of the good(s), detect when the good(s) deviate by time or geographic location from a planned route, and transmit telemetry data, e.g., an alert or an event about such deviation and/or the geographic location of the IMD and the time of day and date when the geographic location of the IMD was determined. Such transmission may be, e.g., to a central processing system, and/or end user(s) and/or other system(s). The path of travel may be outdoors and/or indoors. The alert or the event, for example, may include a geographic location of the good(s) when the alert or the event was sent, a date and time when the alert or the event was sent, and/or notification that there is a deviation from the planned route. Telemetry data means data collected and/or generated by the IMD; telemetry data include for example data derived from IMD sensor(s), a radio, a power management system, input/output circuitry, and/or other components of the IMD; for example data derived from IMD sensor(s) can include event(s), detected by the IMD, and/or alert(s) transmitted by the IMD. Such deviation from the planned route may indicate delivery interruption, theft of the good(s), or fraudulent action being undertaken with the good(s). For example, the goods may have a high value, e.g., gift cards. In this case, for example and to reduce battery power consumption, certain components of the IMD, e.g., a radio and GNSS receiver(s), may be battery powered and operated for a first time interval at different times, e.g., every second periodic time interval. Such second time interval is greater than the first time interval.

Optionally, the IMD can monitor a location of the good(s), detect when the good(s) have moved beyond a specified range of a specified location or is not at the specified location, and transmit telemetry data, e.g., an alert or an event, about such change of location and/or a geographic location of the good(s) when the change of location was determined, a date and time when the change of location was determined, and/or notification that there is a change of location. Such transmission may be, e.g., to a central processing system, and/or end user(s) and/or other system(s). The alert or the event, for example, may include a geographic location of the good(s) when the alert or the event was sent, a date and time when the change of location was determined, and/or notification that there is a change of location. Such movement beyond the specified range may indicate theft or misplacement of the good(s). For example, the goods may be durable medical equipment, e.g., which may have been inadvertently moved within a medical facility or left at a patient's residence. In this case, for example and to reduce battery power consumption, certain components of the IMD, e.g., a radio and GNSS receiver(s), may be battery powered and operated only when movement has been detected by motion sensor(s) such as accelerometers or gyroscopes.

Optionally, the IMD can monitor environmental condition(s) of the good(s), detect when each of one or more environmental condition(s) each fell outside a corresponding range, and transmit telemetry data, e.g., an alert or an event about each environmental condition which fell outside of a corresponding range, and/or a geographic location of the good(s) when the aforementioned changes to the environmental conditions were determined, and/or a date and time when the aforementioned changes to the environmental conditions were determined. Such transmission may be, e.g., to a central processing system, and/or end user(s) and/or other system(s). The alert or the event, for example, may include a geographic location of the good(s) when the aforementioned changes to the environmental conditions were determined, a date and time when the aforementioned changes to the environmental conditions were determined, and/or notification of the aforementioned changes to the environmental conditions. For example, the good(s) may be food, medicinal drugs, cosmetics, or art work which have been exposed to a temperature, humidity, and/or light one or more of which is outside of a permitted range; for example, the good(s) may be transported using cold chain logistics or stored in cold storage to control temperature; the IMD can ascertain if the good(s) have been moved out of the cold chain logistics or storage, or whether a cooling system has failed. In this case, for example and to reduce battery power consumption, certain components of the IMD, e.g., a radio and GNSS receiver(s), may be battery powered and operated only when an out of bounds event has been detected by sensor(s).

Optionally, the IMD can monitor condition(s) of the IMD, detect when each of one or more IMD condition(s) each fall outside a corresponding range, and transmit telemetry data, e.g., an alert or an event about each environmental condition which fell outside of a corresponding range, and/or a geographic location of the good(s) when the aforementioned changes to the environmental conditions were determined, and/or a date and time when the aforementioned changes to the environmental conditions were determined. Such transmission may be, e.g., to a central processing system, and/or end user(s) and/or other system(s). The alert or the event, for example, may include a geographic location of the good(s) when the aforementioned changes to the environmental conditions were determined, a date and time when the aforementioned changes to the environmental conditions were determined, and/or notification of the aforementioned changes to the environmental conditions. For example, one of the IMD sensor(s) is a sensor configured to detect whether a housing of the IMD has been breached, e.g., a light sensor. In this case, for example, upon detecting a breach, the IMD is configured to transmit an alarm message to the WAN, e.g., and to a central processing system which correspondingly alerts end user(s) and/or other system(s).

The IMD will now be further described. The IMD is configured to directly communicate with existing wide area network (WAN) infrastructure, e.g., a cellular network and/or a satellite communications network. Optionally, such communications may use an air interface configured for Internet of Things (IoT) devices, e.g., Long Term Evolution (LTE)-M or NBIoT. As a result, no investment in infrastructure is needed.

Optionally, the IMD may be remotely configured through the WAN by provisioning the IMD with the configuration data. Thus, optionally, an IMD may be reconfigured for different uses, e.g., when reused. Optionally, the work flow of the IMD may also be delivered to the IMD and/or updated from time to time over the WAN.

Optionally, the configuration data includes one or more analysis sets. Each analysis set includes measurement parameter(s), event condition(s), and action(s). The measurement parameter(s) includes type(s) of data to be measured, measurement sensor(s) of the IMD to be used, and/or how often such data is measured. Each type of data to be measured corresponds to one or more measurement sensors of the IMD.

Each analysis set in the configuration data causes the IMD to analyzes measurement data indicated by the measurement parameter(s), ascertain if, where, and/or when event condition(s) have occurred, and upon occurrence of an event condition, then to perform at least one action. The IMD may include a work flow configured to utilize one or more analysis sets in parallel; thus, the IMD may be configured to perform more than one type of analysis in parallel, e.g., detecting out of bounds measurements of temperature and humidity.

Each event condition occurs as a result of data derived from measurement(s) from sensor(s). Optionally, an event condition is satisfied when such data satisfies a condition identified or described in the event condition. For example, an event condition occurs when such derived data is outside a specification range or is less than, equal to, or greater than target data. Each of the specification range and the target data, for example, may be generated by the IMD and/or be specified in the configuration data, e.g., in the event condition or elsewhere, for example in the analysis set, including the event condition. Optionally, such target data is a threshold level or a geographic location.

Upon occurrence of the event, the action(s) are performed. Such an action may be transmission of data related to the event, e.g., an alarm, over the WAN, for example, to a central processing system or another destination, deactivating wholly or partly subcomponent(s) of the IMD to reduce power consumption of the IMD, activating a visual indicator, e.g., a light emitting diode (LED), on the IMD, and/or modifying the measurement parameter(s), event condition(s), and at least one action.

Optionally, embodiments of the invention include intelligent monitoring device(s) and a central processing system. The central processing system is used, for example, to prepare and send configuration data to at least one intelligent monitoring device, to receive location and/or path data from at least one intelligent monitoring device and/or provide such location and/or path data to end user(s) and/or other system(s), and/or to receive or generate alarms and/or providing such alarms to such end user(s) and/or other system(s). The end user(s) may include the owner(s) of the good(s) being monitored and/or an entity transporting or responsible for transporting the good(s).

Each intelligent monitoring device transmits data to and receives data from the central processing system through the WAN. Optionally, LAN(s) and/or PAN(s) may be used to communicatively couple the WAN to the central processing system. Non-limiting examples of a LAN include an Ethernet network or a WiFi network. Non-limiting examples of a PAN include a Bluetooth network and a Zigbee network.

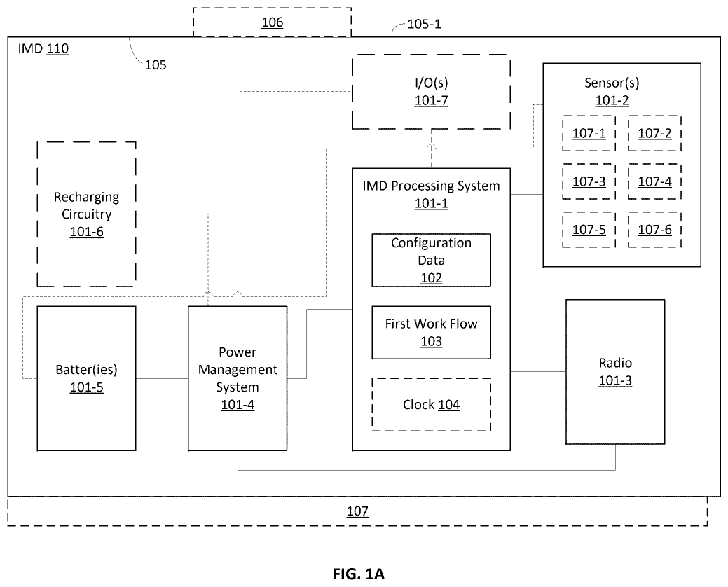

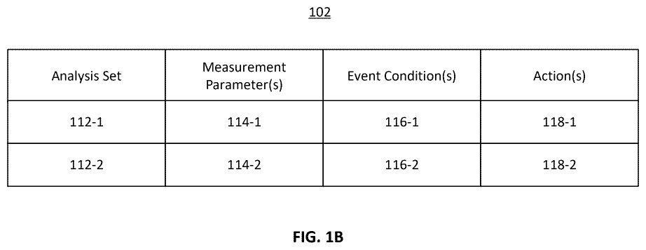

FIG. 1A illustrates a block diagram of one embodiment of an intelligent measurement device 110. The IMD 110 includes a housing 105, an IMD processing system (or a processing circuitry) 101-1, at least one sensor (or sensor(s)) 101-2, a radio 101-3, power management system (or a power management circuitry) 101-4, and at least one battery (or batter(ies)) 101-5. The sensor(s) 101-2 may include Global Navigation Satellite System (GNSS) receiver(s) 107-1, temperature sensor(s) 107-2, humidity sensor(s) 107-3, motion sensor(s), e.g., accelerometer(s), gyroscope(s), and/or compass(s), 107-4, a pressure sensor 107-5, light sensor(s) 107-6, and/or any other type of sensor.

Optionally, one or more of the batter(ies) 101-5 are rechargeable. Optionally, the IMD also includes recharging circuitry (or a recharging system) 101-6 and/or at least one input/output circuit or device (I/O(s)) 101-7. Optionally, the batter(ies) 101-5 either (a) include lithium ion batter(ies), or (b) exclude lithium ion batter(ies) which would permit the IMD 110 to be transported by aircraft.

The housing 105 encloses the other components of the IMD 110, except, e.g., for at least some of the optional I/O(s) 101-7 which may only be partially in and/or on the housing 105. The IMD 110, e.g., the housing 105, has a small form factor, e.g., having a volume equal to or less than the volume of a deck of cards. Optionally, a housing 105 is substantially waterproof, e.g., having an IP67 or IP68 ingress protection rating. Optionally, the housing 105 is food safe. Optionally, a portion of an exterior surface 105-1 of the housing 105 may be covered with an adhesive 107 by which the IMD may be attached to the good(s) or transportation packaging thereof.

Optionally, a visual identifier 106 may be inscribed and/or attached to an exterior surface 105-1 of the housing 105. The visual identifier 106 may include a serial number and/or a code (e.g., a QR, bar, or any other code) which uniquely identifies the IMD 110.

The IMD processing system 101-1 is communicatively coupled to the sensor(s) 101-2, the radio 101-3, and the power management system 101-4, and optionally to the I/O(s) 101-7. The IMD processing system 101-1 is configured to store the configuration data 102 and a first work flow (or processing algorithm) 103. The IMD processing system 101-1 is further configured to execute the first work flow 103 using the configuration data 102. For example, the first work flow 103 is configured to:
(a) use the measurement parameter to cause the IMD processing system 101-1 and the power management system 101-4 to activate, e.g., provide power to, specific sensor(s) of the sensor(s) 101-2, specific I/O(s) of the I/O(s) 101-7, and/or the radio 101-3;
(b) collect data from such specific sensor(s), such specific I/O(s), and/or the radio 101-3;
(c) process the collected data (as illustrated elsewhere herein); and
(d) upon occurrence of an event, transmit telemetry data and/or reconfigure operation of the IMD. Optionally, reconfiguration of operation of the IMD may entail changing analysis set(s) utilized by the first work flow 103. As a result, reconfiguration may optionally include activating other IMD component(s), and/or deactivating, e.g., not providing power to, yet other sensor(s).

Optionally, the IMD processing system 101-1 includes a clock 104 which maintains date and time of day which comprise time stamping data. The optional clock 104 is optionally synchronized, from time to time, with date and time of day data obtained, e.g., from the WAN and/or from another source such as the WAN or one of the sensor(s) 101-2 that are GNSS receiver(s). The GNSS receiver(s) include antenna(s). Examples of GNSSs include without limitation Global Positioning System (GPS), Galileo, BeiDou, and GLONASS (GLObal NAvigation Satellite System).

The IMD processing system 101-1 receives data from and transmits data to the radio 101-3. At least some of the data received by the IMD processing system 101-1 from the radio 101-3 is data, e.g., the configuration data 102 or remote command(s), which the radio 101-3 received from the WAN. At least some of the data sent by the IMD processing system 101-1 to the radio is an alarm generated by the IMD processing system, time of day and date data (e.g., corresponding to the alarm, an event, etc.), and/or data derived from data obtained from the sensor(s) 101-2.

The radio 101-3 is configured to receive data from and transmit data to a WAN, e.g., using an air interface configured for Internet of Things (IoT) devices, for example, LTE-M or NBIoT. However, other air interfaces may be used. The radio includes antenna(s). Optionally, the radio 101-3 includes a system in a package.

The sensor(s) 101-2 include a sensor for geographic location, temperature, humidity, acceleration, rotation, and/or light. Each sensor may periodically or aperiodically generate data. A frequency of periodic sensor measurements and/or telemetry data transmissions may be configurable with a user defined increment which, e.g., can range from second(s) to week(s).

A sensor(s) for geographic location may be receiver(s) for one or more GNSSs and/or an inertial reference unit. Optionally, in lieu of using sensor(s) for geographic location, geographic location may be obtained from data provided by the WAN to the radio 101-3. The sensor(s) for acceleration/deceleration and/or rotation may be an inertial measurement unit, one or more accelerometers, and/or one or more gyroscopes. Optionally, the acceleration/deceleration sensors include one accelerometer for each axis of a coordinate system. Optionally, the gyroscopes include one gyroscope for each axis of a coordinate system. Optionally, each coordinate system may be the Cartesian coordinate system. The light sensor may optionally only detect certain optical spectrums, such as the visible light spectrum. The light sensor, for example, is an ambient light sensor.

The power management system 101-4 is electrically coupled to the IMD processing system 101-1, the radio 101-3, and the batter(ies) 101-5, and is optionally electrically coupled to the sensor(s) 101-2, the recharging circuitry 101-6, and/or the I/O(s) 101-7. The power management system 101-4 is configured to condition power provided by the batter(ies) 101-5 and to provide the conditioned power to the IMD processing system 101-1 and the radio 101-3, and optionally to the sensor(s) 101-2, the recharging circuitry 101-6, and/or the I/O(s) 101-7. Conditioning may include increasing or decreasing a direct current (DC) voltage level of the battery using DC-DC voltage regulator such as a low dropout regulator, a boost converter, a buck converter, or a buck-boost converter. Optionally, to reduce IMD power consumption, the power management system 101-4 may be used to terminate provision of DC electrical power to the radio 101-3, and optionally to the sensor(s) 101-2, the recharging circuitry 101-6, and/or the I/O(s) 101-7

When the optional recharging circuitry 101-6 is used, the power management system optionally may include battery charging circuit(s), e.g., constant current, absorption, trickle and/or pulse battery charging circuits. In such a case, the power management system 101-4 uses power, e.g., DC power, obtained from the recharging circuitry 101-6 to charge the batter(ies) 101-5. The optional recharging circuitry 101-6 may be a wireless receiver for wireless charging, e.g., pursuant to the Qi standard, and/or energy harvesting circuitry configured to harvest ambient energy, e.g., from light, vibrations, heat, and/or ambient electromagnetic radiation.

The optional I/O(s) 101-7 include illumination device(s), e.g., light emitting diode(s) (LED(s)), switch(es), button(s), and/or connector(s) by which to communicate data with and/or provide power to the IMD 110. Each illumination device may indicate one or more conditions of the IMD 110 and/or the good(s) to which the IMD 110 monitors. The switch(s) may be used to activate and/or program an IMD 110. The connector(s) may be used to diagnose a condition of the IMD 110, program the IMD 110, power the IMD 110, and/or recharge the batter(ies) 101-5.

FIG. 1B illustrates a diagram of one embodiment of configuration data 102. The configuration data 102 is organized to include one or more analysis sets 112-1, 112-2. For pedagogical purposes, FIG. 1B is illustrated with two analysis sets 112-1, 112-2. Each analysis set 112-1, 112-2 includes at least one measurement parameter 114-1, 114-2, at least one event condition 116-1, 116-2, and at least one action 118-1, 118-2. Thus, the first analysis set 112-1 includes a first set of measurement parameter(s) 114-1, a first set of event condition(s) 116-1, and a first set of action(s) 118-1. The second analysis set 112-2 includes a second set of measurement parameter(s) 114-1, a second set of event condition(s) 116-1, and a second set of action(s) 118-1.

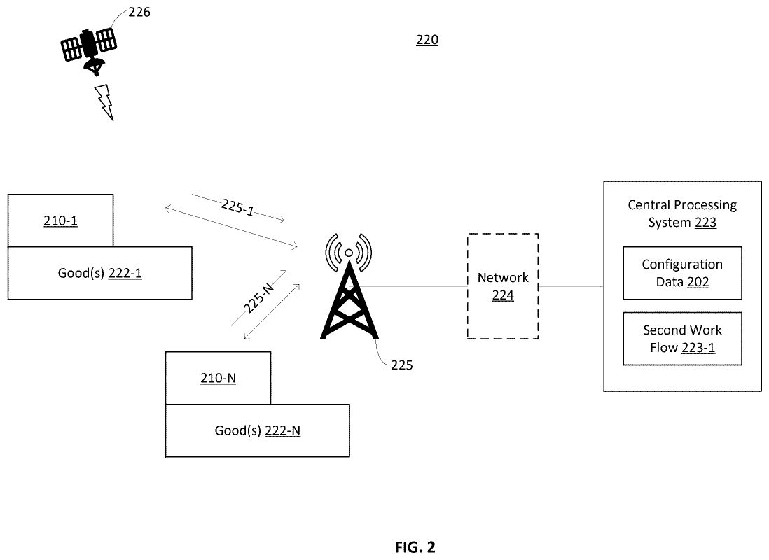

FIG. 2 illustrates a block diagram of one embodiment of a system 220 including intelligent monitoring device(s) 210-1, 210-N (hereinafter “system” 220). The system 220 also includes a first WAN 225, and central processing system (or a central processing circuitry) 223. The first WAN 225 is, for example, a cellular network and/or a satellite communications network.

The system 220 optionally includes a network 224, e.g., a second WAN, a LAN, and/or a PAN. Optionally, the second WAN is the Internet. Optionally, the LAN is an Ethernet network at the premises of the central processing system 223.

There may be one or more IMDs. Each IMD 210-1, 210-N is attached to good(s) 222-1, 222-N or the packaging thereof.

Each IMD 210-1, 210-N is configured to receive geographic location and/or date and time of day data from a GNSS 226 and/or the first WAN 225. Each IMD 210-1, 210-N is further configured to transmit telemetry data 225-1, 225-N at intervals, e.g., periodic intervals, or upon occurrence of an event. Periodic telemetry data transmissions may occur, for example, as frequently as every five minutes. Exemplary events and telemetry data were described above. Other types of events may be used to send telemetry data. Other types of telemetry data may be collected and transmitted. One or more IMDs 210-1, 210-N may optionally be configured to receive configuration data.

The central processing system 223 is, e.g., server(s) and/or a Cloud computing system. Optionally, the central processing system 223 is configured to receive and/or generate configuration data 202 based upon input from end user(s), system administrator(s), and/or other system(s), transmit configuration data 202 to one or more IMDs 210-1, 210-N. Because IMDs may be attached to different types of goods, different IMDs may receive different configuration data. Configuration data received by an IMD 210-1, 210-N may be tailored for the good(s) which the IMD 210-1, 210-N monitors.

The central processing system 223 also includes a second work flow (or processing algorithm) 223-1. The second work flow 223-1 is configured to receive IMD telemetry data 225-1, 225-N. The second work flow is configured to transmit at least a portion of the telemetry data 225-1, 225-N and/or data derived therefrom to end user(s) or other system(s). Optionally, the second work flow 223-1 is also configured to perform additional analysis on the telemetry data 225-1, 225-N and may generate additional data, event(s), and/or alert(s) which may be sent to end user(s) and/or other system(s). For example, the central processing system 223 may receive geographic location data from an IMD 210-1, 210-N and calculate, e.g., using the second workflow, a path of travel of the IMD 210-1, 210-N; optionally, if the central processing system 223, e.g., the second work flow 223-1, detects that such path of travel is deviating by day and time and/or geographic location from a planned travel path, then the central processing system 223, e.g., the second work flow 223-1, sends an alert to end user(s) and/or other system(s). The second work flow 223-1 is configured to generate the configuration data 202 and cause transmission of the generated configuration data 202 to one or more IMDs 210-1, 210-N. The central processing system 223, e.g., the second work flow 223-1, may optionally be configured to remotely activate and/or deactivate one or more, e.g., each of the, IMD(s) communicatively coupled to the central processing system.

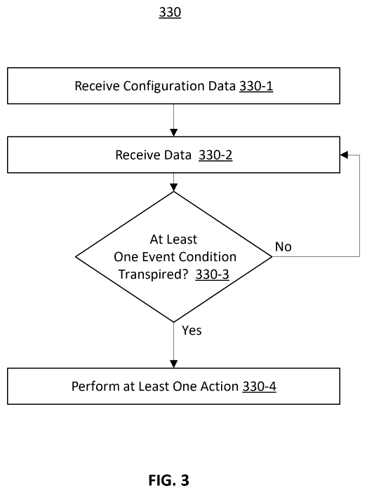

FIG. 3 illustrates a flow diagram of one embodiment of a method 330 of monitoring good(s), e.g. the first work flow. To the extent that the methods shown in any Figures are described herein as being implemented with any of the systems illustrated herein, it is to be understood that other embodiments can be implemented in other ways. Optionally, each method described herein may be implemented by one or more of the apparatuses described herein; however, each method may be implemented with other types of apparatuses. The method 330, for example, may be implemented with the IMD 110 illustrated in FIG. 1A. The blocks of the flow diagrams have been arranged in a generally sequential manner for ease of explanation; however, it is to be understood that this arrangement is merely exemplary, and it should be recognized that the processing associated with the methods (and the blocks shown in the Figures) can occur in a different order (for example, where at least some of the processing associated with the blocks is performed in parallel and/or in an event-driven manner).

In block 330-1, configuration data is received, directly from a WAN, e.g., by an IMD, for example as described elsewhere herein. IMD is configured to be mounted on good(s) to be monitored or on packaging material used in transportation of the good(s). The IMD optionally includes sensor(s). Optionally, as discussed elsewhere herein, the configuration data includes one or more measurement parameters, one or more event conditions, and one or more actions, e.g., in one or more analysis sets.

The configuration data, e.g., the analysis set(s), are used to configure performance of the first work flow, e.g., by indicating which sensor data, event conditions, and/or action(s) to utilize in the first work flow. Analysis set(s) and their use are described further elsewhere herein.

In block 330-2, in response to one or more of the measurement parameters, data about the IMD is received. Optionally, such data includes data about geographic location of the IMD and/or time of day and date when the data was obtained or an event condition occurred; optionally such data further includes data other than the data geographic location of the IMD and the time of day and the date. The time of day and date data may be received, for example, from the WAN through the radio or by a sensor that is a GNSS receiver. Optionally, the received data may also include data about an environmental parameter of the IMD and/or a state variable of the IMD as discussed elsewhere herein.

In block 330-3, whether at least one event condition has transpired is evaluated or determined. Each evaluated event condition is defined in and associated in the configuration data (e.g., in an analysis set) with at least one of the one or more measurement parameters. If no event condition was determined to have transpired, then return to block 330-2.

If at least one event condition was determined to have transpired, then, in block 330-4, at least one action is performed. Each such action is defined in the configuration data (e.g., a corresponding analysis set including the action and the event condition which triggered the action) to be performed upon occurrence of an event associated with the action and which was determined to occur in block 330-3. Examples of such action(s) include transmitting telemetry data, activating other sensor(s), deactivating other sensors, changing the analysis set(s) utilized in performance of the first work flow, and/or any other actions, e.g., described elsewhere herein. Changing of analysis set(s) includes adding and/or removing analysis set(s) utilized in performance of the first work flow.

Optionally, the at least one action includes: (a) transmitting, directly to or over the wide area network, data related to the at least one of the at least one event condition, (b) reducing power consumption of the IMD, (c) activating a visual indicator on the monitor, and/or (d) receiving a different type of data from the at least one sensor. For example, item (a) results in transmission of an indicator of an out of bounds location and/or a location of an IMD, an indicator of an out of specification temperature and/or a measured temperature, an indication of an out of specification humidity and/or a measured humidity, an indication of an out of specification acceleration and/or a measured acceleration, an indication of an out of specification deceleration and/or a measured deceleration, and/or an indication of an out of specification rotation, and/or a measured rotation,

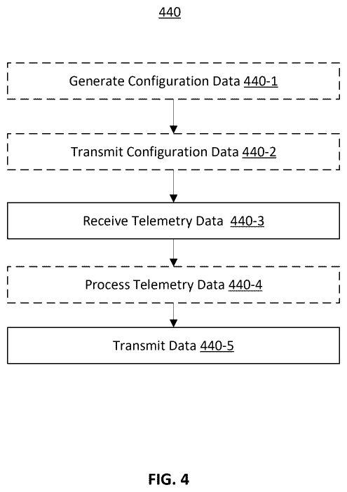

FIG. 4 illustrates a flow diagram of one embodiment of a method 440 of processing telemetry data, e.g. the second work flow. In optional block 440-1, based on input from user(s) and/or other system(s), configuration data is generated. In optional block 440-2, the generated configuration data is transmitted to one or more IMDs.

In block 440-3, telemetry data is received from an IMD. Telemetry data is described elsewhere herein.

In optional block 440-4, the received telemetry data is processed e.g., to determine additional data, event(s), and/or alert(s). Optionally, additional information is derived from the received telemetry data. For example, using a series of data indicating geographic location, at different times, of an IMD with good(s) (and optionally date and time of day when each geographic location was determined), a path of travel of the good(s) may be generated. Optionally, if the path of travel deviates from a stored, expected path of travel by geographic location and/or date and time, then an alert or an event indicating a deviation from the expected path of travel, a last location of the good(s), and/or a date and time of day when the last location was determined may be transmitted to end user(s) and/or other system(s). Optionally, the expected path of travel is stored in the central processing system 223.

In block 440-5, data is transmitted to end user(s) and/or other system(s). Such data includes at least a portion of the telemetry data, an alert or an event derived from the telemetry data, and/or other information derived from the telemetry data.

The processing system (or processing circuitry) described herein may be implemented by processor circuitry communicatively coupled to memory circuitry. The processor circuitry may include one or more microprocessors, microcontrollers, digital signal processing (DSP) elements, application-specific integrated circuits (ASICs), and/or field programmable gate arrays (FPGAs). In this exemplary embodiment, processor circuitry includes or functions with software programs, firmware, or other computer readable instructions for carrying out various process tasks, calculations, and control functions, used in the methods described herein. These instructions are typically tangibly embodied on any storage media (or computer readable medium) used for storage of computer readable instructions or data structures.

The memory circuitry can be implemented with any available storage media (or computer readable medium) that can be accessed by a general purpose or special purpose computer or processor, or any programmable logic device. Suitable computer readable medium may include storage or memory media such as semiconductor, magnetic, and/or optical media. For example, computer readable media may include conventional hard disks, Compact Disk-Read Only Memory (CD-ROM), DVDs, volatile or non-volatile media such as Random Access Memory (RAM) (including, but not limited to, Dynamic Random Access Memory (DRAM)), Read Only Memory (ROM), Electrically Erasable Programmable ROM (EEPROM), and/or flash memory. Combinations of the above are also included within the scope of computer readable media.

Methods of the invention can be implemented in computer readable instructions, such as program modules or applications, which may be stored in the computer readable medium that is part of (optionally the memory circuitry and/or processing circuitry) or communicatively coupled to the processing circuitry, and executed by the processing circuitry, optionally the processor circuitry. Generally, program modules or applications include routines, programs, objects, data components, data structures, algorithms, and the like, which perform particular tasks or implement particular abstract data types.

### Exemplary Embodiments

Example 1 includes a method of monitoring one or more goods, the method comprising: receiving, directly from a wide area network, configuration data for an intelligent monitoring device (IMD) configured to be mounted on the one or more goods or on packaging used to transport the one or more goods; wherein the configuration data includes one or more measurement parameters, one or more event conditions, and one or more actions; in response to the one or more measurement parameters, receiving data about the IMD including data about a geographic location of the IMD, and a time of day and a date about when the geographic location of the IMD was obtained or an event condition occurred; using at least a portion of the received data, evaluating whether at least one of the one or more event conditions has transpired, wherein each evaluated event conditions is associated with at least one of the one or more measurement parameters; and determining that the at least one of the one or more event conditions has transpired, then performing at least one of the one or more actions, wherein each performed action is associated with one or more transpired event conditions; wherein the transpired actions include at least one of: (a) transmitting, direction over the wide area network, data about the one or more transpired event conditions, (b) reducing power consumption of one or more first components of the IMD, (c) activating one or more second components of the IMD, and (d) receiving data of at least one other data type.

Example 2 includes the method of Example 1, wherein receiving data about the IMD further includes data other than the data about the geographic location of the IMD and the time of day and the date.

Example 3 includes the method of any of Examples 1-2, wherein the data about each of the one or more transpired event conditions includes a time of day and a date about when and a geographic location about where a transpired event condition transpired.

Example 4 includes the method of any of Examples 1-3, wherein the one or more measurement parameters indicate that an environmental parameter of the IMD is to be measured; wherein the one or more event conditions includes determining that a measurement of the environmental parameter is outside of a range of values of such environmental parameter; wherein the one or more actions includes transmitting, directly over the wide area network, data indicating that a measured environmental parameter is outside the range of values of the environmental parameter, a time of day and a date about when and a geographic location about where the measured environmental parameter was outside of the range of values of the environmental parameter; and wherein determining that the at least one of the one or more event conditions has transpired, then performing the at least one of the one or more actions comprises determining that the measured environmental parameter is outside of the range of values of the environmental parameter, then transmitting, directly over the wide area network, data indicating that the measured environmental parameter is outside the range of values of the environmental parameter, the time of day and the date about when and the geographic location about where the measured environmental parameter is outside of the range of values of the environmental parameter.

Example 5 includes the method of Example 4, wherein the environmental parameter is either temperature, humidity, or pressure.

Example 6 includes the method of any of Examples 1-5, wherein the one or more measurement parameters indicate that a state variable of the IMD is to be measured; wherein the one or more event conditions includes determining that a measurement of the state variable of the IMD is outside of a range of values of such state variable; wherein the one or more actions includes transmitting, directly over the wide area network, data indicating that a measured state variable of the IMD is outside the range of values of the state variable, a time of day and a date about when and a geographic location about where the measured state variable was outside of the range of values of the state variable; and wherein determining that the at least one of the one or more event conditions has transpired, then performing the at least one of the one or more actions comprises determining that the measured state variable is outside of the range of values of the state variable, then transmitting, directly over the wide area network, data indicating that the measured state variable is outside the range of values of the state variable, the time of day and the date about when and the geographic location about where the measured state variable is outside of the range of values of the state variable.

Example 7 includes the method of Example 6, wherein the state variable is either orientation of the IMD, velocity of the IMD, movement of the IMD, vibration of the IMD, acceleration of the IMD, or deceleration of the IMD.

Example 8 includes a non-transitory computer readable medium storing a program causing at least one processor to execute a process to monitor one or more goods, the process comprising: receiving, directly from a wide area network, configuration data for an intelligent monitoring device (IMD) configured to be mounted on the one or more goods or on packaging used to transport the one or more goods; wherein the configuration data includes one or more measurement parameters, one or more event conditions, and one or more actions; in response to the one or more measurement parameters, receiving data about the IMD including data about a geographic location of the IMD, and a time of day and a date about when the geographic location of the IMD was obtained or an event condition occurred; using at least a portion of the received data, evaluating whether at least one of the one or more event conditions has transpired, wherein each evaluated event conditions is associated with at least one of the one or more measurement parameters; and determining that the at least one of the one or more event conditions has transpired, then performing or causing performance of at least one of the one or more actions, wherein each performed action is associated with one or more transpired event conditions; wherein the transpired actions include at least one of: (a) transmitting, directly over the wide area network, data about the one or more transpired event conditions, (b) reducing power consumption of one or more first components of the IMD, (c) activating one or more second components of the IMD, and (d) receiving data of at least one other data type.

Example 9 includes the non-transitory computer readable medium of Example 8, wherein receiving data about the IMD further includes data other than the data about the geographic location of the IMD and the time of day and the date.

Example 10 includes the non-transitory computer readable medium of any of Examples 8-9, wherein the data about each of the one or more transpired event conditions includes a time of day and a date about when and a geographic location about where a transpired event condition transpired.

Example 11 includes the non-transitory computer readable medium of any of Examples 8-10, wherein the one or more measurement parameters indicate that an environmental parameter of the IMD is to be measured; wherein the one or more event conditions includes determining that a measurement of the environmental parameter is outside of a range of values of such environmental parameter; wherein the one or more actions includes causing transmission, directly over the wide area network, data indicating that a measured environmental parameter is outside the range of values of the environmental parameter, a time of day and a date about when and a geographic location about where the measured environmental parameter was outside of the range of values of the environmental parameter; and wherein determining that the at least one of the one or more event conditions has transpired, then performing or causing performance of the at least one of the one or more actions comprises determining that the measured environmental parameter is outside of the range of values of the environmental parameter, then causing transmission, directly over the wide area network, data indicating that the measured environmental parameter is outside the range of values of the environmental parameter, the time of day and the date about when and the geographic location about where the measured environmental parameter is outside of the range of values of the environmental parameter.

Example 12 includes the non-transitory computer readable medium of Example 11, wherein the environmental parameter is either temperature, humidity, or pressure.

Example 13 includes the non-transitory computer readable medium of any of Examples 8-12, wherein the one or more measurement parameters indicate that a state variable of the IMD is to be measured; wherein the one or more event conditions includes determining that a measurement of the state variable of the IMD is outside of a range of values of such state variable; wherein the one or more actions includes causing transmission, directly over the wide area network, data indicating that a measured state variable of the IMD is outside the range of values of the state variable, a time of day and a date about when and a geographic location about where the measured state variable was outside of the range of values of the state variable; and wherein determining that the at least one of the one or more event conditions has transpired, then performing or causing performance of the at least one of the one or more actions comprises determining that the measured state variable is outside of the range of values of the state variable, then transmitting, directly over the wide area network, data indicating that the measured state variable is outside the range of values of the state variable, the time of day and the date about when and the geographic location about where the measured state variable is outside of the range of values of the state variable.

Example 14 includes the non-transitory computer readable medium of Example 13, wherein the state variable is either orientation of the IMD, velocity of the IMD, movement of the IMD, vibration of the IMD, acceleration of the IMD, or deceleration of the IMD.

Example 15 includes an intelligent monitoring device (IMD) configured to monitor one or more goods, the IMD comprising: processing circuitry; one or more sensors communicatively coupled to the processing circuitry; a radio communicatively coupled to the processing circuitry, and configured to be directly communicatively coupled to a wide area network; one or more batteries; power management circuitry electrically coupled to the one or more batteries, the processing circuitry, and the radio; wherein the processing circuitry is configured to: receive, through the radio and from the wide area network, configuration data for IMD, wherein the IMD configured to be mounted on the one or more goods or on packaging used to transport the one or more goods; wherein the configuration data includes one or more measurement parameters, one or more event conditions, and one or more actions; in response to the one or more measurement parameters, receiving data, from the radio and/or the one or more sensors, about the IMD including data about a geographic location of the IMD, and a time of day and a date about when the geographic location of the IMD was obtained or an event condition occurred; using at least a portion of the received data, evaluating whether at least one of the one or more event conditions has transpired, wherein each evaluated event conditions is associated with at least one of the one or more measurement parameters; and determining that the at least one of the one or more event conditions has transpired, then performing or causing performance of at least one of the one or more actions, wherein each performed action is associated with one or more transpired event conditions; wherein the transpired actions include at least one of: (a) transmitting, directly over the wide area network, data about the one or more transpired event conditions, (b) reducing power consumption of one or more first components of the IMD, (c) activating one or more second components of the IMD, and (d) receiving data of at least one other data type.

Example 16 includes the IMD of Example 15, wherein receiving data about the IMD further includes data other than the data about the geographic location of the IMD and the time of day and the date.

Example 17 includes the IMD of any of Examples 15-16, wherein the data about each of the one or more transpired event conditions includes a time of day and a date about when and a geographic location about where a transpired event condition transpired.

Example 18 includes the IMD of any of Examples 15-17, wherein the one or more measurement parameters indicate that an environmental parameter of the IMD is to be measured; wherein the one or more event conditions includes determining that a measurement of the environmental parameter is outside of a range of values of such environmental parameter; wherein the one or more actions includes causing transmission, directly over the wide area network, data indicating that a measured environmental parameter is outside the range of values of the environmental parameter, a time of day and a date about when and a geographic location about where the measured environmental parameter was outside of the range of values of the environmental parameter; and wherein determining that the at least one of the one or more event conditions has transpired, then performing or causing performance of the at least one of the one or more actions comprises determining that the measured environmental parameter is outside of the range of values of the environmental parameter, then causing transmission, directly over the wide area network, data indicating that the measured environmental parameter is outside the range of values of the environmental parameter, the time of day and the date about when and the geographic location about where the measured environmental parameter is outside of the range of values of the environmental parameter.

Example 19 includes the IMD of Example 18, wherein the environmental parameter is either temperature, humidity, or pressure.

Example 20 includes the IMD of any of Examples 15-19, wherein the one or more measurement parameters indicate that a state variable of the IMD is to be measured; wherein the one or more event conditions includes determining that a measurement of the state variable of the IMD is outside of a range of values of such state variable; wherein the one or more actions includes causing transmission, directly over the wide area network, data indicating that a measured state variable of the IMD is outside the range of values of the state variable, a time of day and a date about when and a geographic location about where the measured state variable was outside of the range of values of the state variable; and wherein determining that the at least one of the one or more event conditions has transpired, then performing or causing performance of the at least one of the one or more actions comprises determining that the measured state variable is outside of the range of values of the state variable, then transmitting, directly over the wide area network, data indicating that the measured state variable is outside the range of values of the state variable, the time of day and the date about when and the geographic location about where the measured state variable is outside of the range of values of the state variable.

Example 21 includes the IMD of Example 20, wherein the state variable is either orientation of the IMD, velocity of the IMD, movement of the IMD, vibration of the IMD, acceleration of the IMD, or deceleration of the IMD.

Example 22 includes the IMD of any of Examples 15-21, wherein the one or more sensors include an accelerometer, a gyroscope, an inertial reference unit, a Global Navigation Satellite System receiver, a pressure sensor, a humidity sensor, and a temperature sensor.

Example 23 includes the IMD of Example 20, further comprising a recharging circuitry electrically coupled to the power management circuitry and configured to provide electrical energy to recharge the at least one of the one or more batteries.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

1. A method of monitoring one or more goods, the method comprising:
receiving, directly from a wide area network, configuration data for an intelligent monitoring device (IMD) configured to be mounted on the one or more goods or on packaging used to transport the one or more goods;
wherein the configuration data includes one or more measurement parameters, one or more event conditions, and one or more actions;
in response to the one or more measurement parameters, receiving data about the IMD including data about a geographic location of the IMD, and a time of day and a date about when the geographic location of the IMD was obtained or an event condition occurred;
using at least a portion of the received data, evaluating whether at least one of the one or more event conditions has transpired, wherein each evaluated event conditions is associated with at least one of the one or more measurement parameters; and
determining that the at least one of the one or more event conditions has transpired, then performing at least one of the one or more actions, wherein each performed action is associated with one or more transpired event conditions;
wherein the transpired actions include at least one of: (a) transmitting, direction over the wide area network, data about the one or more transpired event conditions, (b) reducing power consumption of one or more first components of the IMD, (c) activating one or more second components of the IMD, and (d) receiving data of at least one other data type.

2. The method of claim 1, wherein receiving data about the IMD further includes data other than the data about the geographic location of the IMD and the time of day and the date.

3. The method of claim 1, wherein the data about each of the one or more transpired event conditions includes a time of day and a date about when and a geographic location about where a transpired event condition transpired.

4. The method of claim 1, wherein the one or more measurement parameters indicate that an environmental parameter of the IMD is to be measured;
wherein the one or more event conditions includes determining that a measurement of the environmental parameter is outside of a range of values of such environmental parameter;
wherein the one or more actions includes transmitting, directly over the wide area network, data indicating that a measured environmental parameter is outside the range of values of the environmental parameter, a time of day and a date about when and a geographic location about where the measured environmental parameter was outside of the range of values of the environmental parameter; and
wherein determining that the at least one of the one or more event conditions has transpired, then performing the at least one of the one or more actions comprises determining that the measured environmental parameter is outside of the range of values of the environmental parameter, then transmitting, directly over the wide area network, data indicating that the measured environmental parameter is outside the range of values of the environmental parameter, the time of day and the date about when and the geographic location about where the measured environmental parameter is outside of the range of values of the environmental parameter.

5. The method of claim 4, wherein the environmental parameter is either temperature, humidity, or pressure.

6. The method of claim 1, wherein the one or more measurement parameters indicate that a state variable of the IMD is to be measured;
wherein the one or more event conditions includes determining that a measurement of the state variable of the IMD is outside of a range of values of such state variable;
wherein the one or more actions includes transmitting, directly over the wide area network, data indicating that a measured state variable of the IMD is outside the range of values of the state variable, a time of day and a date about when and a geographic location about where the measured state variable was outside of the range of values of the state variable; and
wherein determining that the at least one of the one or more event conditions has transpired, then performing the at least one of the one or more actions comprises determining that the measured state variable is outside of the range of values of the state variable, then transmitting, directly over the wide area network, data indicating that the measured state variable is outside the range of values of the state variable, the time of day and the date about when and the geographic location about where the measured state variable is outside of the range of values of the state variable.

7. The method of claim 6, wherein the state variable is either orientation of the IMD, velocity of the IMD, movement of the IMD, vibration of the IMD, acceleration of the IMD, or deceleration of the IMD.

8. A non-transitory computer readable medium storing a program causing at least one processor to execute a process to monitor one or more goods, the process comprising:
receiving, directly from a wide area network, configuration data for an intelligent monitoring device (IMD) configured to be mounted on the one or more goods or on packaging used to transport the one or more goods;
wherein the configuration data includes one or more measurement parameters, one or more event conditions, and one or more actions;
in response to the one or more measurement parameters, receiving data about the IMD including data about a geographic location of the IMD, and a time of day and a date about when the geographic location of the IMD was obtained or an event condition occurred;
using at least a portion of the received data, evaluating whether at least one of the one or more event conditions has transpired, wherein each evaluated event conditions is associated with at least one of the one or more measurement parameters; and
determining that the at least one of the one or more event conditions has transpired, then performing or causing performance of at least one of the one or more actions, wherein each performed action is associated with one or more transpired event conditions;
wherein the transpired actions include at least one of: (a) transmitting, directly over the wide area network, data about the one or more transpired event conditions, (b) reducing power consumption of one or more first components of the IMD, (c) activating one or more second components of the IMD, and (d) receiving data of at least one other data type.

9. The non-transitory computer readable medium of claim 8, wherein receiving data about the IMD further includes data other than the data about the geographic location of the IMD and the time of day and the date.

10. The non-transitory computer readable medium of claim 8, wherein the data about each of the one or more transpired event conditions includes a time of day and a date about when and a geographic location about where a transpired event condition transpired.

11. The non-transitory computer readable medium of claim 8, wherein the one or more measurement parameters indicate that an environmental parameter of the IMD is to be measured;
wherein the one or more event conditions includes determining that a measurement of the environmental parameter is outside of a range of values of such environmental parameter;
wherein the one or more actions includes causing transmission, directly over the wide area network, data indicating that a measured environmental parameter is outside the range of values of the environmental parameter, a time of day and a date about when and a geographic location about where the measured environmental parameter was outside of the range of values of the environmental parameter; and
wherein determining that the at least one of the one or more event conditions has transpired, then performing or causing performance of the at least one of the one or more actions comprises determining that the measured environmental parameter is outside of the range of values of the environmental parameter, then causing transmission, directly over the wide area network, data indicating that the measured environmental parameter is outside the range of values of the environmental parameter, the time of day and the date about when and the geographic location about where the measured environmental parameter is outside of the range of values of the environmental parameter.

12. The non-transitory computer readable medium of claim 11, wherein the environmental parameter is either temperature, humidity, or pressure.

13. The non-transitory computer readable medium of claim 8, wherein the one or more measurement parameters indicate that a state variable of the IMD is to be measured;
wherein the one or more event conditions includes determining that a measurement of the state variable of the IMD is outside of a range of values of such state variable;
wherein the one or more actions includes causing transmission, directly over the wide area network, data indicating that a measured state variable of the IMD is outside the range of values of the state variable, a time of day and a date about when and a geographic location about where the measured state variable was outside of the range of values of the state variable; and
wherein determining that the at least one of the one or more event conditions has transpired, then performing or causing performance of the at least one of the one or more actions comprises determining that the measured state variable is outside of the range of values of the state variable, then transmitting, directly over the wide area network, data indicating that the measured state variable is outside the range of values of the state variable, the time of day and the date about when and the geographic location about where the measured state variable is outside of the range of values of the state variable.

14. The non-transitory computer readable medium of claim 13, wherein the state variable is either orientation of the IMD, velocity of the IMD, movement of the IMD, vibration of the IMD, acceleration of the IMD, or deceleration of the IMD.

15. An intelligent monitoring device (IMD) configured to monitor one or more goods, the IMD comprising:
processing circuitry;
one or more sensors communicatively coupled to the processing circuitry;
a radio communicatively coupled to the processing circuitry, and configured to be directly communicatively coupled to a wide area network;
one or more batteries;
power management circuitry electrically coupled to the one or more batteries, the processing circuitry, and the radio;
wherein the processing circuitry is configured to:
receive, through the radio and from the wide area network, configuration data for IMD, wherein the IMD configured to be mounted on the one or more goods or on packaging used to transport the one or more goods;
wherein the configuration data includes one or more measurement parameters, one or more event conditions, and one or more actions;
in response to the one or more measurement parameters, receiving data, from the radio and/or the one or more sensors, about the IMD including data about a geographic location of the IMD, and a time of day and a date about when the geographic location of the IMD was obtained or an event condition occurred;
using at least a portion of the received data, evaluating whether at least one of the one or more event conditions has transpired, wherein each evaluated event conditions is associated with at least one of the one or more measurement parameters; and
determining that the at least one of the one or more event conditions has transpired, then performing or causing performance of at least one of the one or more actions, wherein each performed action is associated with one or more transpired event conditions;
wherein the transpired actions include at least one of: (a) transmitting, directly over the wide area network, data about the one or more transpired event conditions, (b) reducing power consumption of one or more first components of the IMD, (c) activating one or more second components of the IMD, and (d) receiving data of at least one other data type.

16. The IMD of claim 15, wherein receiving data about the IMD further includes data other than the data about the geographic location of the IMD and the time of day and the date.

17. The IMD of claim 15, wherein the data about each of the one or more transpired event conditions includes a time of day and a date about when and a geographic location about where a transpired event condition transpired.

18. The IMD of claim 15, wherein the one or more measurement parameters indicate that an environmental parameter of the IMD is to be measured;
wherein the one or more event conditions includes determining that a measurement of the environmental parameter is outside of a range of values of such environmental parameter;
wherein the one or more actions includes causing transmission, directly over the wide area network, data indicating that a measured environmental parameter is outside the range of values of the environmental parameter, a time of day and a date about when and a geographic location about where the measured environmental parameter was outside of the range of values of the environmental parameter; and
wherein determining that the at least one of the one or more event conditions has transpired, then performing or causing performance of the at least one of the one or more actions comprises determining that the measured environmental parameter is outside of the range of values of the environmental parameter, then causing transmission, directly over the wide area network, data indicating that the measured environmental parameter is outside the range of values of the environmental parameter, the time of day and the date about when and the geographic location about where the measured environmental parameter is outside of the range of values of the environmental parameter.

19. The IMD of claim 18, wherein the environmental parameter is either temperature, humidity, or pressure.

20. The IMD of claim 15, wherein the one or more measurement parameters indicate that a state variable of the IMD is to be measured;
wherein the one or more event conditions includes determining that a measurement of the state variable of the IMD is outside of a range of values of such state variable;
wherein the one or more actions includes causing transmission, directly over the wide area network, data indicating that a measured state variable of the IMD is outside the range of values of the state variable, a time of day and a date about when and a geographic location about where the measured state variable was outside of the range of values of the state variable; and
wherein determining that the at least one of the one or more event conditions has transpired, then performing or causing performance of the at least one of the one or more actions comprises determining that the measured state variable is outside of the range of values of the state variable, then transmitting, directly over the wide area network, data indicating that the measured state variable is outside the range of values of the state variable, the time of day and the date about when and the geographic location about where the measured state variable is outside of the range of values of the state variable.

21. The IMD of claim 20, wherein the state variable is either orientation of the IMD, velocity of the IMD, movement of the IMD, vibration of the IMD, acceleration of the IMD, or deceleration of the IMD.

22. The IMD of claim 15, wherein the one or more sensors include an accelerometer, a gyroscope, an inertial reference unit, a Global Navigation Satellite System receiver, a pressure sensor, a humidity sensor, and a temperature sensor.

23. The IMD of claim 20, further comprising a recharging circuitry electrically coupled to the power management circuitry and configured to provide electrical energy to recharge the at least one of the one or more batteries.
